(19) United States
(12) Patent Application Publication
(10) Pub. No.: US 2025/0246684 A1
(43) Pub. Date: Jul. 31, 2025

(54) NONAQUEOUS ELECTROLYTE SECONDARY BATTERY

(71) Applicant: Panasonic Energy Co., Ltd., Moriguchi-shi, Osaka (JP)

(72) Inventors: Yuta Ichikawa, Osaka (JP); Masanori Maekawa, Osaka (JP); Takuya Shinomiya, Tokushima (JP); Hiroyuki Fujimoto, Osaka (JP)

(73) Assignee: Panasonic Energy Co., Ltd., Moriguchi-shi, Osaka (JP)

(21) Appl. No.: 18/866,634

(22) PCT Filed: May 22, 2023
(86) PCT No.: PCT/JP2023/018933

§ 371 Date: Nov. 18, 2024

(30) Foreign Application Priority Data
May 30, 2022 (JP) 2022-087637

(51) Int. Cl. H01M 10/0568; H01M 4/02; H01M 4/525; H01M 4/583; H01M 4/62; H01M 10/0569; H01M 10/0587

(52) U.S. Cl. CPC H01M 10/0568; H01M 4/525; H01M 4/583; H01M 4/623; H01M 4/625; H01M 10/0569; H01M 10/0587; H01M 2004/027; H01M 2004/028; H01M 2300/0037

(57) ABSTRACT

This nonaqueous electrolyte secondary battery is provided with: an electrode body that comprises a first electrode and a second electrode, an electrolyte solution; and an outer package. The first electrode has a rectangular shape, and comprises a collector and a mixture layer that is formed on the surface of the collector; the mixture layer has a first region, a second region and a third region sequentially from one end toward the other end in the short-side direction of the first electrode; the respective widths of the first and the third region in the short-side direction of the first electrode are 1% to 20% of the length of the first electrode in the short-side direction; the mixture layer contains an electrolyte salt; and the respective contents of the electrolyte salt in the first and the third region are higher than the content of the electrolyte salt in the second region.

### TECHNICAL FIELD

The present disclosure relates to a non-aqueous electrolyte secondary battery.

### BACKGROUND ART

A positive electrode and a negative electrode, which are electrodes of a non-aqueous electrolyte secondary battery, each have a current collector and a mixture layer formed on a surface of the current collector. The mixture layer includes an active material that can reversibly occlude and release Li ions, and the like.

Patent Literature 1 discloses art of incorporating a part of an electrolyte salt, which is to be contained in a finally required electrolyte liquid, in a positive electrode in advance in view of improving a liquid injection property in secondary battery manufacture. Patent Literature 2 discloses art of incorporating an electrolyte in a positive electrode in advance in order to inhibit decrease in a concentration of the electrolyte salt inside the positive electrode after repeated charge-discharge cycles.

### CITATION LIST

### Patent Literature

PATENT LITERATURE 1: Japanese Unexamined Patent Application Publication No. 2011-192561
PATENT LITERATURE 2: International Publication No. WO2018/025469

### SUMMARY

In recent years, the secondary battery has been required to have further improved battery characteristics such as durability and battery capacity. The present inventors have made intensive investigation, and consequently found that decrease in the battery capacity due to charge-discharge cycle cannot be sufficiently inhibited in some cases even with containing the electrolyte salt in the electrode. In addition, increase in a content rate of the electrolyte salt in the electrode relatively decreases a content rate of the active material in the electrode to decrease the battery capacity. The art disclosed in Patent Literature 1 and 2 does not investigate achievement of both the battery capacity and durability of the secondary battery, and still has room for improvement.

It is an advantage of the present disclosure to provide a non-aqueous electrolyte secondary battery with high capacity and excellent durability.

A non-aqueous electrolyte secondary battery of an aspect of the present disclosure comprises: an electrode assembly including a first electrode and a second electrode that have different polarities from each other; an electrolyte liquid; and an exterior housing the electrode assembly and the electrolyte liquid, wherein the first electrode has a rectangular shape, and has a current collector and a mixture layer formed on a surface of the current collector, the mixture layer has a first region, a second region, and a third region in this order from one end to the other end in a short direction of the first electrode, each of a width of the first region and a width of the third region in the short direction of the first electrode is greater than or equal to 1% and less than or equal to 20% of a length of the short direction of the first electrode, the mixture layer includes an electrolyte salt, and each of a content rate of the electrolyte salt in the first region and a content rate of the electrolyte salt in the third region is higher than a content rate of the electrolyte salt in the second region.

According to the non-aqueous electrolyte secondary battery of an aspect of the present disclosure, both the high capacity and the high durability can be achieved.

### BRIEF DESCRIPTION OF DRAWINGS

FIG. 1 is an axial sectional view of a cylindrical secondary battery of an example of an embodiment.

FIG. 2 is a front view illustrating a positive electrode according to an example of an embodiment with an unwound state.

### DESCRIPTION OF EMBODIMENTS

Hereinafter, an example of an embodiment of a cylindrical secondary battery according to the present disclosure will be described in detail with reference to the drawing. In the following description, specific shapes, materials, values, directions, and the like, which are examples for facilitating understanding of the present invention, may be appropriately modified with specifications of secondary batteries. Hereinafter, a cylindrical secondary battery in which a wound electrode assembly is housed in a cylindrical exterior will be exemplified, but the electrode assembly is not limited to the wound electrode assembly, and may be a stacked electrode assembly in which a plurality of positive electrodes and a plurality of negative electrodes are alternately stacked one by one via a separator. The exterior is not limited to the cylindrical exterior, and may be, for example, a rectangular exterior or a coin-shaped exterior. The exterior may be a pouch composed of laminated sheets including a metal layer and a resin layer. The description a numerical value (A) to a numerical value (B)” herein means greater than or equal to the value (A) and less than or equal to the value (B).

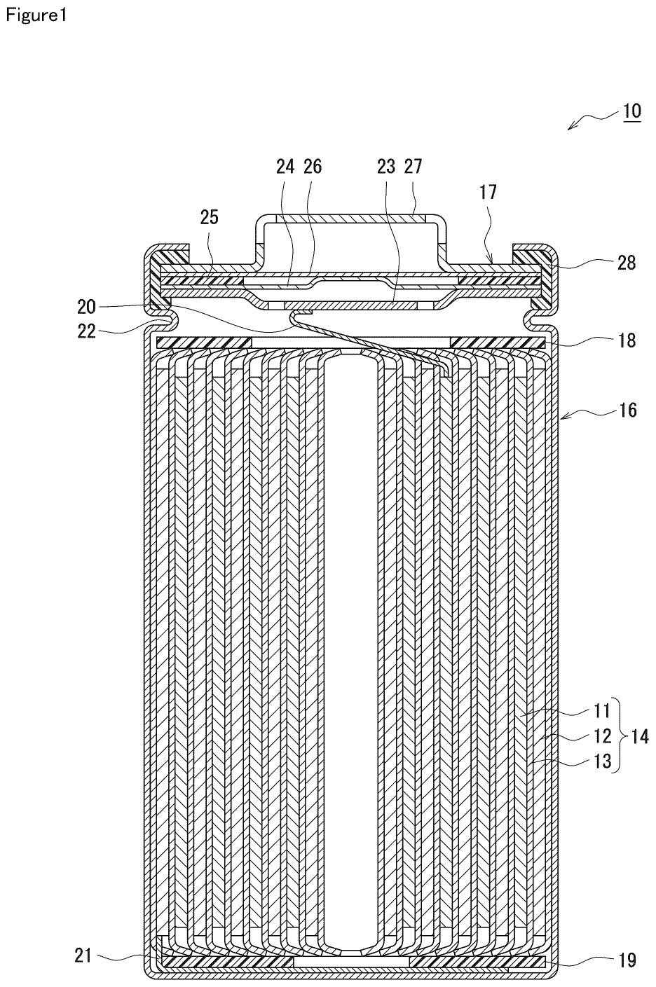

FIG. 1 is an axial sectional view of a cylindrical secondary battery 10 of an example of an embodiment. As illustrated in FIG. 1, the secondary battery 10 comprises a wound electrode assembly 14, an electrolyte liquid, and an exterior 16 housing the electrode assembly 14 and the electrolyte. The electrode assembly 14 includes a positive electrode 11, a negative electrode 12, and a separator 13, and has a wound structure in which the positive electrode 11 and the negative electrode 12 are spirally wound via the separator 13. The exterior 16 is a bottomed cylindrical metallic container having an opening on one side in an axial direction, and the opening of the exterior 16 is capped with a sealing assembly 17. Hereinafter, for convenience of description, the sealing assembly 17 side of the battery will be described as the upper side, and the bottom side of the exterior 16 will be described as the lower side.

All of the positive electrode 11, the negative electrode 12, and the separator 13 that constitute the electrode assembly 14 is an elongated body having a rectangular shape, and are spirally wound in a longitudinal direction to be alternately stacked in a radial direction of the electrode assembly 14. The separator 13 separates the positive electrode 11 and the negative electrode 12 each other. To prevent precipitation of lithium, the negative electrode 12 is formed to be one size larger than the positive electrode 11. That is, the negative electrode 12 is formed to be longer than the positive electrode 11 in a longitudinal direction and a short direction. Two of the separator 13 are formed to be one size larger than at least the positive electrode 11, and disposed to sandwich the positive electrode 11. The electrode assembly 14 comprises: a positive electrode lead 20 connected to the positive electrode 11 by welding or the like; and a negative electrode lead 21 connected to the negative electrode 12 by welding or the like. In the electrode assembly 14, a longitudinal direction of the positive electrode 11 and the negative electrode 12 is a winding direction, and a short direction of the positive electrode 11 and the negative electrode 12 is an axial direction. That is, an end surface in the short direction of the positive electrode 11 and the negative electrode 12 forms an end surface in the axial direction of the electrode assembly 14.

Insulating plates 18 and 19 are disposed on the upper and lower sides of the electrode assembly 14, respectively. In the example illustrated in FIG. 1, the positive electrode lead 20 extends through a through hole in the insulating plate 18 toward a side of the sealing assembly 17, and the negative electrode lead 21 extends along an outside of the insulating plate 19 toward the bottom side of the exterior 16. The positive electrode lead 20 is connected to a lower surface of an internal terminal plate 23 of the sealing assembly 17 by welding or the like, and a cap 27, which is a top plate of the sealing assembly 17 electrically connected to the internal terminal plate 23, becomes a positive electrode terminal. The negative electrode lead 21 is connected to a bottom inner surface of the exterior 16 by welding or the like, and the exterior 16 becomes a negative electrode terminal.

A gasket 28 is provided between the exterior 16 and the sealing assembly 17 to achieve sealability inside the battery. On the exterior 16, a grooved portion 22 in which a part of a side wall thereof projects inward for supporting the sealing assembly 17 is formed. The grooved portion 22 is preferably formed in a circular shape along a circumferential direction of the exterior 16, and supports the sealing assembly 17 with the upper surface thereof. The sealing assembly 17 is fixed on the upper part of the exterior 16 with the grooved portion 22 and with an end of the opening of the exterior 16 caulked to the sealing assembly 17.

The sealing assembly 17 has a stacked structure of the internal terminal plate 23, a lower vent member 24, an insulating member 25, an upper vent member 26, and the cap 27 in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected at respective central parts thereof, and the insulating member 25 is interposed between the respective circumferential parts thereof. If the internal pressure of the battery increases due to abnormal heat generation, the lower vent member 24 is deformed so as to push the upper vent member 26 up toward the cap 27 side and breaks, and thereby a current pathway between the lower vent member 24 and the upper vent member 26 is cut off. If the internal pressure further increases, the upper vent member 26 breaks, and gas is discharged through the opening of the cap 27.

Next, the positive electrode 11, the negative electrode 12, the separator 13, and the electrolyte liquid will be described in detail. Hereinafter, an example in which the positive electrode 11 is the first electrode and the negative electrode 12 is the second electrode will be described. Note that the present embodiment is not limited to this example. For example, the negative electrode 12 may be the first electrode. The second electrode may have a feature similar to that of the first electrode, and both the positive electrode 11 and the negative electrode 12 may have the feature of the first electrode.

### [Positive Electrode]

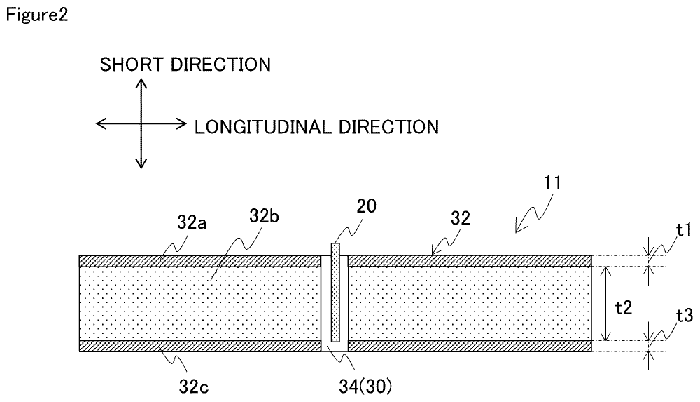

The positive electrode 11 will be described with reference to FIG. 2. FIG. 2 is a front view illustrating the positive electrode 11 according to an example of the embodiment with an unwound state. The positive electrode 11 has a positive electrode current collector 30 and a positive electrode mixture layer 32 formed on a surface of the positive electrode current collector 30. The positive electrode mixture layer 32 is preferably formed on both surfaces of the positive electrode current collector 30. For the positive electrode current collector 30, a foil of a metal stable within a potential range of the positive electrode 11, such as aluminum and an aluminum alloy, a film in which such a metal is disposed on a surface layer, or the like can be used.

The positive electrode mixture layer 32 has a first region 32a, a second region 32b, and a third region 32c in this order from one end to the other end in a short direction of the positive electrode 11. In the present embodiment, the one end is positioned on the upper side of the secondary battery 10, and the other end is positioned on the lower side of the secondary battery 10.

Each of a width t1 of the first region 32a and a width t3 of the third region 32c in the short direction of the positive electrode 11 is greater than or equal to 1% and less than or equal to 20% of a length of the short direction of the positive electrode 11. The width t1 of the first region 32a and the width t3 of the third region 32c may be different from each other, but preferably the same as each other. A width t2 of the second region 32b is greater than or equal to 60% and less than or equal to 98% of the length of the short direction of the positive electrode 11.

The positive electrode mixture layer 32 includes an electrolyte salt. The positive electrode mixture layer 32 further includes, for example, a positive electrode active material, a binder, and a conductive agent. Each of a content rate of the electrolyte salt in the first region 32a and a content rate of the electrolyte salt in the third region 32c is higher than a content rate of the electrolyte salt in the second region 32b. This relationship can achieve both the high capacity and the high durability. Here, the content rate of the electrolyte salt in the first region 32a refers to a proportion of a mass of the electrolyte salt relative to a total mass of the first region 32a, and the content rates of the electrolyte salt in the second region 32b and the third region 32c are similarly defined.

The content rates of the electrolyte salt in the first region 32a and the third region 32c are preferably greater than or equal to 0.1 mass % and less than or equal to 10 mass %, more preferably greater than or equal to 0.1 mass % and less than or equal to 5 mass %, and further preferably greater than or equal to 0.1 mass % and less than or equal to 1 mass %.

The content rate of the electrolyte salt in the second region 32b is, for example, less than 0.1 mass %. The second region 32b is preferably free of the electrolyte salt. This configuration can increase a content rate of the positive electrode active material in the second region 32b to increase the battery capacity. The content rate of the positive electrode active material in each of the first region 32a, the second region 32b, and the third region 32c is, for example, greater than or equal to 80 mass % and less than or equal to 99 mass % relative to the total mass of each region.

The electrolyte salt included in the positive electrode mixture layer 32 is preferably a lithium salt. Examples of the lithium salt include LiBF₄, LiClO₄, LiPF₆, LiAsF₆, LiSbF₆, LiAlCL₄, LiSCN, LiCF₃SO₃, LiCF₃CO₂, Li(P(C₂O₄) F₄), LiPF₆₋ₓ(CₙF₂ₙ₊₁)ₓ (1<x<₆, and “n” represents 1 or 2), LiB₁₀Cl₁₀, LiCl, LiBr, LiI, lithium chloroborane, a lithium lower aliphatic carboxylate, borate salts such as Li₂B₄O₇ and Li(B(C₂O₄) F₂), and imide salts such as LiN(SO₂CF₃)₂ and LiN(C₁F₂ₗ₊₁SO₂)(CₘF₂ₗ₊₁SO₂) {“l” and “m” represent integers of greater than or equal to 1}. These lithium salts may be used singly, or a plurality of types thereof may be mixed for use. Among them, LiPF₆ is preferably used from the viewpoints of ion conductivity, electrochemical stability, and the like. The electrolyte salt included in the positive electrode mixture layer 32 may be the same as an electrolyte salt included in an electrolyte liquid, described later.

Examples of the positive electrode active material included in the positive electrode mixture layer 32 may include a lithium-transition metal composite oxide containing a transition metal such as Ni. The lithium-transition metal composite oxide preferably includes Ni and at least one element selected from the group consisting of Mn, Co, and Al. A content of Ni in the lithium-transition metal composite oxide is, for example, greater than or equal to 60 mol % and less than or equal to 95 mol % relative to a total number of moles of metal elements excluding Li. The lithium-transition metal composite oxide May be represented by, for example, the general formula LiₐNiₓM1_{y}M2_{z} O_{2-b}, wherein ≤0.8≤a≤1.2, 0.6≤x≤0.95, 0.05≤y≤0.4, 0≤z≤0.15, 0≤b<0.05, x+y+z=1, M1 represents at least one element selected from the group consisting of Mn, Co, and Al, and M2 represents at least one element selected from the group consisting of Fe, Ti, Si, Nb, Zr, Mo, and Zn.

Examples of the conductive agent included in the positive electrode mixture layer 32 include carbon-based particles such as carbon black (CB), acetylene black (AB), Ketjenblack, carbon nanotube (CNT), graphene, and graphite. These may be used singly, or may be used in combination of two or more.

Examples of the binder included in the positive electrode mixture layer 32 include a fluororesin such as polytetrafluoroethylene (PTFE) and polyvinylidene fluoride (PVDF), a polyimide resin, an acrylic resin, a polyolefin resin, and polyacrylonitrile (PAN). These may be used singly, or may be used in combination of two or more thereof.

The positive electrode active material, the conductive agent, and the binder included in the first region 32a, the second region 32b, and the third region 32c may be different from each other, but preferably the same as each other.

A method for producing the positive electrode 11 is not particularly limited, and the positive electrode 11 can be produced as follows, for example.
(1) Each of a first positive electrode mixture slurry for the first region 32a and the third region 32c and a second positive electrode mixture slurry for the second region 32b is produced. For example, only the first positive electrode mixture slurry includes the electrolyte salt. Both the first positive electrode mixture slurry and the second positive electrode mixture slurry include the positive electrode active material, the conductive agent, and the binder, for example.
(2) The first positive electrode mixture slurry and the second positive electrode mixture slurry are applied along the longitudinal direction of the positive electrode 11 in a stripe shape so as to be adjacent to each other in the short direction. At this time, the positive electrode exposed portion 34 is provided by, for example, intermittent application in which the first positive electrode mixture slurry is not applied on a part of the positive electrode current collector 30.
(3) The applied slurry is dried, and then the coating film is rolled with a roller to produce the positive electrode 11.

### [Negative Electrode]

The negative electrode 12 has, for example, a negative electrode current collector and a negative electrode mixture layer formed on a surface of the negative electrode current collector. The negative electrode mixture layer is preferably formed on both surfaces of the negative electrode current collector. For the negative electrode current collector, a foil of a metal stable within a potential range of the negative electrode, such as copper and a copper alloy, a film in which such a metal is disposed on a surface layer thereof, and the like may be used.

The negative electrode mixture layer includes, for example, a negative electrode active material and a binder. A content of the negative electrode active material in the negative electrode mixture layer is, for example, greater than or equal to 80 mass % and less than or equal to 99 mass % relative to a total mass of the negative electrode mixture layer. The negative electrode 12 can be produced by, for example, applying a negative electrode mixture slurry including the negative electrode active material, the binder, and the like on the surface of the negative electrode current collector, drying the coating film, and then compressing the coating film by using a roller or the like.

The negative electrode active material included in the negative electrode mixture layer is not particularly limited as long as it can reversibly occlude and release Li ions, and carbon materials such as graphite are typically used. The graphite may be any of natural graphite such as flake graphite, massive graphite, and amorphous graphite, and artificial graphite such as massive artificial graphite and graphitized mesophase carbon microbead. As the negative electrode active material, a metal that forms an alloy with Li, such as Si and Sn, a metal compound including Si, Sn, and the like, a lithium-titanium composite oxide, and the like may also be used. For example, a silicon oxide represented by SiOₓ (“x” represents greater than or equal to 0.5 and less than or equal to 1.6), a silicon-containing material in which Si fine particles are dispersed in a lithium silicate phase represented by Li_{2y}SiO_{(2+y)}(0<y<2), a silicon-containing material in which Si fine particles are dispersed in a carbon phase, or the like may be used in combination with the graphite.

Example of the binder included in the negative electrode mixture layer include styrene-butadiene rubber (SBR), nitrile-butadiene rubber (NBR), carboxymethylcellulose (CMC) or a salt thereof (which may be CMC-Na, CMC-K, CMC-NH₄, and the like, or a partially neutralized salt), polyacrylic acid (PAA) or a salt thereof (which may be PAA-Na, PAA-K, and the like, or a partially neutralized salt), and polyvinyl alcohol (PVA). These may be used singly, or may be used in combination of two or more thereof.

### [Separator]

For the separator 13, a porous sheet having an ion permeation property and an insulation property, or the like is used, for example. Specific examples of the porous sheet include a fine porous thin film, a woven fabric, and a nonwoven fabric. As a material for the separator, a polyolefin resin such as polyethylene and polypropylene, cellulose, or the like is preferable. The separator 13 may be a laminate having a cellulose fiber layer and a thermoplastic resin fiber layer such as an olefin resin. The separator 13 may be a multi-layer separator including a polyethylene layer and a polypropylene layer, or a separator in which a material such as an aramid resin and ceramic is applied on a surface of the separator 13 may be used.

### [Electrolyte Liquid]

The electrolyte liquid is a liquid electrolyte including a non-aqueous solvent and an electrolyte salt dissolved in the non-aqueous solvent. For the non-aqueous solvent, esters, ethers, nitriles such as acetonitrile, amides such as dimethylformamide, a mixed solvent of two or more thereof, or the like may be used, for example. The non-aqueous solvents may contain a halogen-substituted derivative in which the hydrogen atoms of these solvents are at least partially replaced with a halogen atom such as fluorine.

Examples of the esters include: cyclic carbonates such as ethylene carbonate (EC), propylene carbonate (PC), and butylene carbonate; chain carbonates such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylates such as γ-butyrolactone and γ-valerolactone; and chain carboxylates such as methyl acetate, ethyl acetate, propyl acetate, methyl propionate (MP), and ethyl propionate.

Examples of the ethers include: cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and a crown ether; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted derivative, fluorinated cyclic carbonates such as fluoroethylene carbonate (FEC), fluorinated chain carbonates, fluorinated chain carboxylates such as methyl fluoropropionate (FMP), and the like are preferably used.

The electrolyte salt included in the electrolyte liquid may be different from the electrolyte salt included in the positive electrode 11, but preferably the same as the electrolyte salt included in the positive electrode 11. The electrolyte salt included in the electrolyte liquid preferably includes a lithium salt, and more preferably includes LiPF₆. A concentration of the lithium salt is preferably greater than or equal to 0.5 mol and less than or equal to 2.0 mol per litter of the solvent.

### EXAMPLES

Hereinafter, the present disclosure will be further described with Examples, but the present disclosure is not limited to these Examples.

### [Production of Positive Electrode]

As a first positive electrode active material, a lithium-composite oxide represented by LiNi_{0.80}CO_{0.15}Al_{0.05}O₂ was used. The first positive electrode active material, acetylene black (AB), polyvinylidene fluoride (PVDF), and lithium hexafluorophosphate (LiPF₆) were mixed at a mass ratio of 100:1:0.9:0.5, and kneaded while adding N-methylpyrrolidone (NMP) to prepare a first positive electrode mixture slurry. In addition, the first positive electrode active material, acetylene black (AB), and polyvinylidene fluoride (PVDF) were mixed at a mass ratio of 100:1:0.9, and kneaded while adding N-methylpyrrolidone (NMP) to prepare a second positive electrode mixture slurry.

On a surface of a positive electrode current collector with a rectangular shape composed of aluminum foil, the first positive electrode mixture slurry and the second positive electrode mixture slurry were applied in a stripe shape relative to a longitudinal direction, and dried. The slurries were similarly applied and dried also on the back surface. The dried coating film was rolled by using a roller, and then cut to a predetermined electrode size to produce a positive electrode in which a positive electrode mixture layer was formed on both the surfaces of the positive electrode current collector. The positive electrode mixture layer had the form the same as in FIG. 2, and formed by applying the first positive electrode mixture slurry on the first region and the third region and by applying the second positive electrode mixture slurry on the second region. In the short direction of the positive electrode, a ratio between a width of the first region, a width of the second region, and a width of the third region was 5:90:5. On a substantially center portion in the longitudinal direction of the positive electrode, a positive electrode exposed portion was provided by intermittent application of the first positive electrode mixture slurry and the second positive electrode mixture slurry, and a positive electrode lead made of aluminum was welded with the positive electrode exposed portion.

### [Production of Negative Electrode]

98 parts by mass of graphite, 1 part by mass of carboxymethylcellulose (CMC), and 1 part by mass of styrene-butadiene rubber (SBR) were mixed, and an appropriate amount of water was added to prepare a negative electrode mixture slurry. Then, the negative electrode mixture slurry was applied on both surfaces of a negative electrode current collector with a rectangular shape composed of copper foil so that a negative electrode exposed portion in which the negative electrode current collector was exposed was formed on a terminal winding end. The coating film was dried and then rolled, and cut to a predetermined electrode size to produce a negative electrode in which a negative electrode mixture layer was formed on both surfaces of the negative electrode current collector. A negative electrode lead made of nickel was welded with the negative electrode exposed portion.

### [Preparation of Electrolyte Liquid]

Into a mixed solvent composed of ethylene carbonate (EC) and ethyl methyl carbonate (EMC) (EC:EMC=3:7 at a volume ratio), lithium hexafluorophosphate (LiPF₆) was dissolved so that the concentration was 1.5 mol/L to prepare an electrolyte liquid.

### [Production of Secondary Battery]

The positive electrode and the negative electrode were wound via a separator made of a polyolefin resin to produce a wound electrode assembly. Insulating plates were respectively disposed on the upper and lower sides of the electrode assembly, and the electrode assembly was housed in a cylindrical exterior. Then, the negative electrode lead was welded with a bottom of the exterior, and the positive electrode lead was welded with a sealing assembly. Thereafter, the electrolyte was injected inside the exterior by a pressure reduction method, and then an end of an opening of the exterior was caulked to the sealing assembly via a gasket and sealed to produce a secondary battery.

### Example 2

A secondary battery was produced in the same manner as in Example 1 except that, in the production of the positive electrode, the ratio between the width of the first region, the width of the second region, and the width of the third region in the short direction of the positive electrode was changed to 2.5:95:2.5.

### Example 3

A secondary battery was produced in the same manner as in Example 1 except that, in the production of the positive electrode, the ratio between the width of the first region, the width of the second region, and the width of the third region in the short direction of the positive electrode was changed to 10:80:10.

### Comparative Example 1

A secondary battery was produced in the same manner as in Example 1 except that, in the production of the positive electrode, only the second positive electrode mixture slurry was applied on the entire surface of the positive electrode current collector excluding the positive electrode exposed portion.

### Comparative Example 2

A secondary battery was produced in the same manner as in Example 1 except that, in the production of the positive electrode, only the first positive electrode mixture slurry was applied on the entire surface of the positive electrode current collector excluding the positive electrode exposed portion.

### [Evaluation of Initial Battery Capacity and Capacity Retention]

Under an environment temperature of 25° C., the secondary battery of Examples and Comparative Examples was charged at a constant current of 0.3 C until a battery voltage reached 4.2 V, and then charged at a constant voltage of 4.2 V until a current value reached 0.01 C. Thereafter, the secondary battery was discharged at a constant current of 0.5° C. until 2.5 V. This charge and discharge was specified as one cycle, and 100 cycles were performed. With the following formula, a capacity retention in the charge-discharge cycle of the secondary battery of each of Examples and each of Comparative Examples was determined. A discharge capacity at the 1st cycle was specified as an initial battery capacity.

$$Capacity retention = ( Discharge capacity at 200 th cycle / Discharge capacity at 1 st cycle ) \times 100$$

Table 1 shows the evaluation results of the secondary batteries of Examples and Comparative Examples. In Table 1, the initial battery capacity of Examples 1 to 3 and Comparative Example 1 is shown as a value relative to a value of the initial battery capacity of Comparative Example 2 being 100. In Table 1, the capacity retention of Examples 1 to 3 and Comparative Example 2 is shown as a value relative to a value of the capacity retention of Comparative Example 1 being 100.

TABLE 1

| | Proportion of area | | |
|---|---|---|---|
| | of region including | | |
| | electrolyte salt in | Initial | |
| | positive electrode | battery | Cycle |
| | mixture layer | capacity | retention |
| Example 1 | 10% | 100.4 | 157 |
| Example 2 | 5% | 100.5 | 121 |
| Example 3 | 20% | 100.4 | 129 |
| Comparative Example 1 | 0% | 100.5 | 100 |
| Comparative Example 2 | 100% | 100 | 143 |

The secondary batteries of Examples 1 to 3 exhibit high initial battery capacity and capacity retention, and can achieve both the high capacity and the high durability. Meanwhile, the secondary battery of Comparative Example 1 exhibits low capacity retention, and the secondary battery of Comparative Example 2 exhibits low initial battery capacity. Therefore, it is understood that the secondary battery with high capacity and excellent durability can be obtained by setting the content rate of the electrolyte salt within the predetermined range near both the ends in the short direction in the mixture layer to be larger than the content rate of the electrolyte salt in the center portion in the short direction.

The present disclosure is further described with the following embodiments.

### Constitution 1:

A non-aqueous electrolyte secondary battery, comprising:
an electrode assembly including a first electrode and a second electrode that have different polarities from each other;
an electrolyte liquid; and
an exterior housing the electrode assembly and the electrolyte liquid, wherein
the first electrode has a rectangular shape, and has a current collector and a mixture layer formed on a surface of the current collector,
the mixture layer has a first region, a second region, and a third region in this order from one end to the other end in a short direction of the first electrode,
each of a width of the first region and a width of the third region in the short direction of the first electrode is greater than or equal to 1% and less than or equal to 20% of a length of the short direction of the first electrode,
the mixture layer includes an electrolyte salt, and
each of a content rate of the electrolyte salt in the first region and a content rate of the electrolyte salt in the third region is higher than a content rate of the electrolyte salt in the second region.

### Constitution 2:

The non-aqueous electrolyte secondary battery according to claim 1, wherein the first electrode and the second electrode are wound via a separator in the electrode assembly,

### Constitution 3:

The non-aqueous electrolyte secondary battery according to Constitution 1 or 2, wherein the first electrode is a positive electrode.

### Constitution 4:

The non-aqueous electrolyte secondary battery according to any one of Constitutions 1 to 3, wherein the electrolyte salt includes lithium hexafluorophosphate. Constitution 5:

The non-aqueous electrolyte secondary battery according to any one of Constitutions 1 to 4, wherein the second region is free of the electrolyte salt.

### REFERENCE SIGNS LIST

10 Secondary battery, 11 Positive electrode, 12 Negative electrode, 13 Separator, 14 Electrode assembly, 16 Exterior, 17 Sealing assembly, 18, 19 Insulating plate, 20 Positive electrode lead, 21 Negative electrode lead, 22 Grooved portion, 23 Internal terminal plate, 24 Lower vent member, 25 Insulating member, 26 Upper vent member, 27 Cap, 28 Gasket, 30 Positive electrode current collector, 32 Positive electrode mixture layer, 32a First region, 32b Second region, 32c Third region, 34 Positive electrode exposed portion

1. A non-aqueous electrolyte secondary battery, comprising:
an electrode assembly including a first electrode and a second electrode that have different polarities from each other;
an electrolyte liquid; and
an exterior housing the electrode assembly and the electrolyte liquid, wherein
the first electrode has a rectangular shape, and has a current collector and a mixture layer formed on a surface of the current collector,
the mixture layer has a first region, a second region, and a third region in this order from one end to the other end in a short direction of the first electrode,
each of a width of the first region and a width of the third region in the short direction of the first electrode is greater than or equal to 1% and less than or equal to 20% of a length of the short direction of the first electrode,
the mixture layer includes an electrolyte salt, and
each of a content rate of the electrolyte salt in the first region and a content rate of the electrolyte salt in the third region is higher than a content rate of the electrolyte salt in the second region.

2. The non-aqueous electrolyte secondary battery according to claim 1, wherein the first electrode and the second electrode are wound via a separator in the electrode assembly.

3. The non-aqueous electrolyte secondary battery according to claim 1, wherein the first electrode is a positive electrode.

4. The non-aqueous electrolyte secondary battery according to claim 1, wherein the electrolyte salt includes lithium hexafluorophosphate.

5. The non-aqueous electrolyte secondary battery according to claim 1, wherein the second region is free of the electrolyte salt.
